(19) United States
(12) Patent Application Publication
(10) Pub. No.: US 2006/0146547 A1
(43) Pub. Date: Jul. 6, 2006

(54) LAMP HANGING STRUCTURE

(76) Inventor: Wen-Chang Wu, Chunghua (TW)

Correspondence Address: Wen-Chang Wu, 235 Chung-Ho, Box 8-24, Taipei, TW

(21) Appl. No.: 10/445,419

(22) Filed: May 28, 2003

(51) Int. Cl. F21S 8/06

(52) U.S. Cl. 362/405; 362/396

(57) ABSTRACT

A lamp hanging structure comprises a wire connecting box; an edge of the wire connecting box having two ears; a hanging rod; each of two ends of the hanging rod being installed with an fixing hole which is corresponding to a respective one of two positioning holes; a retaining block having a threaded section; a hook being embedded into the retaining block and the elastomer extending upwards to the hook; an elastomer resisting against the hook so as to seal the hook. In assembly, the hanging rod is locked to the positioning holes of the ears. Then the hook is suspended from the hanging rod. The hanging rod resists against the elastomer of the retaining block so that the hanging rod slides through the elastomer to enter into the hook. It can restore automatically through the elastomer so that the hook is positioned to the hanging rod.

### BACKGROUND OF THE INVENTION

1. Field of the Invention

The present invention relates to lamp devices, and particularly to a lamp hanging structure which can be assembled easily and has a longer lifetime.

2. Description of the Related Art

In the prior art, the wire connecting box of a lamp is locked to a retaining block. The center of the block has a hole. A threaded tube is locked to the retaining block. The threaded tube passes through a hole in the retaining block. Then the threaded tube is fixed by screwing with a male nut so that the retaining block will not fall down. A lower side of the retaining block is fixed with a hanging ring so that a lamp can be suspended from the ring. Thereby, the buckling block can load the lamp.

However, above prior art has the following defect. Firstly, the prior art retaining block is made of iron which is cheap, but weak. It is often that after it is used for a time period, the retaining block cracks and thus is dangerous. Moreover, in assembly, the lamp is heavy and much labor is necessary in assembly. Thus the cost is high and the operation is inconvenient.

### SUMMARY OF THE INVENTION

Accordingly, the primary object of the present invention is to provide a lamp hanging structure which can be installed easily and has a longer lifetime.

To achieve above objects, the present invention provides a lamp hanging structure which comprises a wire connecting box; an edge of the wire connecting box having two ears; a hanging rod; each of two ends of the hanging rod being installed with an fixing hole which is corresponding to a respective one of two positioning holes; a retaining block having a threaded section; a hook being embedded into the retaining block and the elastomer extending upwards to the hook; an elastomer resisting against the hook so as to seal the hook. In assembly, the hanging rod is locked to the positioning holes of the ears. Then the hook is suspended from the hanging rod. The hanging rod resists against the elastomer of the retaining block so that the hanging rod slides through the elastomer to enter into the hook. It can restore automatically through the elastomer so that the hook is positioned to the hanging rod.

The various objects and advantages of the present invention will be more readily understood from the following detailed description when read in conjunction with the appended drawing.

### BRIEF DESCRIPTION OF THE DRAWINGS

FIG. 1 is an exploded perspective view of the wire connecting box of the present invention

FIG. 2 is an assembled perspective view of the wire connecting box of the present invention.

FIG. 3 shows one embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

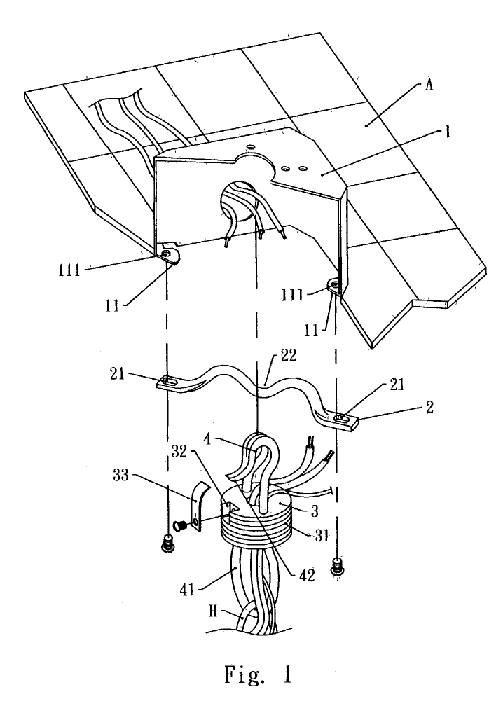

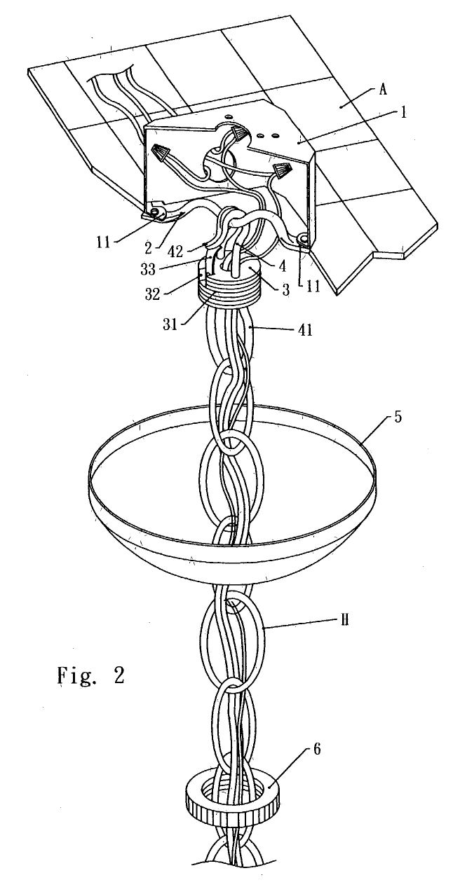

Referring to FIGS. 1 and 2, a wire connecting box 1 is embedded into and fixed to the ceiling A. An edge of the wire connecting box I has two ears 11 which are symmetrically arranged. Each ear 11 is formed with a positioning hole 111. A hanging rod 2 has two ends, each end being installed with a fixing hole 21. A middle section thereof is installed with a buckling neck 22. A retaining block 3 has a threaded section 31. The threaded section 31 has a longitudinal retaining groove 32. An elastomer 33, is fixed in the retaining groove 32. A hook 4 is embedded into the retaining block 3 and the elastomer 33 extends upwards to the hook 4. A lower end of the retaining block 3 has a buckling ring 41. The hook 4 and the buckling ring 41 are integrally formed. An elastomer 33 resists against the hook 4 so as to seal a hooking end 42 of the hook 4.

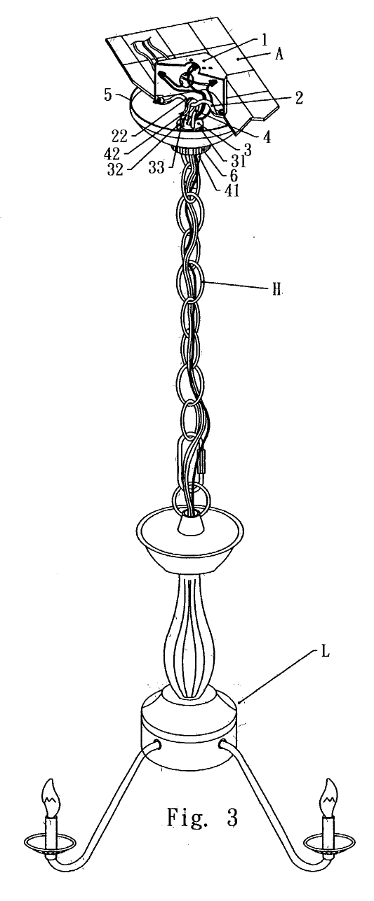

Referring to FIGS. 2 and 3, in assembly, the hanging rod 2 is locked to the positioning holes 222 of the ears 11 of the wire connecting box 1. Then the hook 4 is suspended from the hanging rod 2. The hanging rod 2 resists against the elastomer 33 of the retaining block 3 so that the hanging rod 2 slides through the elastomer 33 to enter into the hook 4. Then it can restore automatically through the elastomer 33 so that the hook 4 is positioned to the hanging rod 2. Then the buckling neck 22 at the middle section of the hanging rod 2 serves to confine the hook 4 to the center of the hanging rod 2 so as to avoid the shift of the hook 4. A cover 5 serves to cover the wire connecting box 1 and it is locked to the threaded section 31 of the retaining block 3 so that the cover 5 is tightly retained to the ceiling A. By above mentioned structure, a lamp L is suspended to the buckling ring 41 by a chain H so that the lamp L is carried by the hook 4 and no force is applied to the retaining block 3. Thereby, the lifetime is prolonged and installation of the present invention is convenient and easily.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A lamp hanging structure comprising:
a wire connecting box; an edge of the wire connecting box having two ears which are symmetrically arranged; each ear being formed with a positioning hole;
a hanging rod; each of two ends of the hanging rod being installed with a fixing hole which is corresponding to a respective one of two positioning holes;
a retaining block having a threaded section; the threaded section having a longitudinally retaining groove; an elastomer being fixed in the retaining groove;
a hook being embedded into the retaining block and the elastomer extending upwards to the hook; the elastomer resisting against the hook so as to seal a hooking end of the hook;
wherein in assembly, the hanging rod is locked to the positioning holes of the ears; then the hook is suspended from the hanging rod; the hanging rod resists against the elastomer of the retaining block so that the hanging rod slides through the elastomer to enter into the hook; the elastomer can restore automatically so that the hook is positioned to the hanging rod; thus, a buckling neck at a middle section of the hanging rod serves to confine the hook.

2. The lamp hanging structure as claimed in claim 1, wherein the middle section of the hanging rod has the buckling neck for correcting a position of the hook.

3. The lamp hanging structure as claimed in claim 1, wherein a lower end of the retaining block has a buckling ring; the hook and the buckling ring are integrally formed; a lamp is connected to the buckling ring and thus the hook can suspend the lamp.
